(19) United States
(12) Patent Application Publication
(10) Pub. No.: US 2011/0233799 A1
(43) Pub. Date: Sep. 29, 2011

(54) METHOD FOR MANUFACTURING LENS HAVING FUNCTIONAL NANOPATTERN

(75) Inventor: Shinill Kang, Seoul (KR)

(73) Assignee: Industry-Academic Cooperaton Foundation, Yonsei University, Seoul (KR)

(21) Appl. No.: 13/062,750

(22) PCT Filed: Jan. 29, 2009
(86) PCT No.: PCT/KR2009/000416

§ 371 Date: May 26, 2011

(30) Foreign Application Priority Data
Sep. 8, 2008 (KR) 10-2008-0088412

(51) Int. Cl. B29D 11/00

(52) U.S. Cl. 264/1.38; 264/1.7

(57) ABSTRACT

A method for manufacturing a lens having a functional nanopattern. A photonic crystal pattern is formed on a mold member, and the mold member is pressed against the curved portion of the lens such that the photonic crystal pattern is formed on the surface of the polymer attached to the surface of the curved portion of the lens, thus forming a photonic crystal pattern on the curved surface of the lens, minimizing reflection losses and improving light transmittance.

### TECHNICAL FIELD

The present invention relates to a method for manufacturing a lens having a functional nanopattern, which increases light transmittance by minimizing reflections from the surface of the lens.

### BACKGROUND ART

In general, when light passes through the interface between two media having different refractive indices, the light is subjected to Fresnel loss, attributable to the difference in the refractive indices of the media, and loss caused by total internal reflection.

Fresnel loss occurs when a portion of light is reflected from the interface between surfaces having discontinuous refractive indices, whereas total internal reflection refers to the phenomenon in which light that travels from one medium having a higher refractive index into another medium having a lower refractive index is reflected from the interface, rather than passing through it, if the incident angle is greater than the critical angle.

FIG. 1 is a view showing the transmission and reflection of light when the light travels from a medium 10 having a refractive index greater than 1 into the air, which has a refractive index of 1.

Referring to FIG. 1, when light strikes the surface of a medium 10 at an angle θ1 that is not greater than the critical angle, a portion of the light (arrow “A”) exits the medium, and the remaining portion of the light (arrow “B”) is reflected from the surface of the medium 10 and enters the medium 10 again. Meanwhile, when light strikes the surface of the medium at an angle greater than the critical angle, all of it is reflected into the medium.

Rays of light that are reflected into the medium (arrows “B” and “C”) cause loss, since they are absorbed by the medium or travel in an unintended direction through it.

In order to reduce reflections occurring at the surface of the medium as described above, a method of applying a single-layer or multilayer thin film on the surface of the medium in a vacuum chamber is currently used. This method is based on destructive interference of light that is reflected from the interface coated with the thin film, and a multilayer thin film is generally used in order to realize an effect throughout the entire range of visible light.

The method of applying the thin film on the surface of the medium has problems such as low productivity and high cost.

In addition, another approach for reducing reflections occurring at the surface of the medium includes a method of using a functional nanopattern. The functional nanopattern is made of a photonic crystal pattern. “Photonic crystal pattern” refers to a structure in which different refractive indices are periodically repeated in one or more directions. The photonic crystal pattern is not diffracted, since its period does not exceed the half of the wavelength. If the photonic crystal structure is properly selected, the variation in the diffraction index between the two media, which have different diffraction indices, is gradual, thereby decreasing Fresnel reflection and significantly decreasing total reflection. Consequently, when light is emitted from a medium into the air, it is possible to significantly increase light efficiency.

Methods of forming such a photonic crystal pattern in the surface of a medium include E-beam radiation, X-ray lithography, focused ion beam, laser hololithography, and the like. However, there is a problem in that application to a wide surface of the medium incurs high cost.

Consequently, an approach of forming a photonic crystal pattern using nano imprinting, which can reduce cost, has been developed.

FIGS. 2 to 5 are views showing the sequence of the process of forming a photonic crystal pattern in the surface of a medium using nano-imprinting technology of the related art.

First, as shown in FIG. 2, a polymer 22 is uniformly applied to a predetermined thickness on the surface of a substrate 20, and a mold member 30, with a photonic crystal pattern 32 engraved in the surface thereof, is positioned on the upper surface of the substrate 20.

Afterwards, as shown in FIG. 3, the mold member 30 is pressed so that the photonic crystal pattern 32 formed in the mold member 30 is transferred to the polymer 22. Here, the polymer 22 is cured by applying heat or radiating ultraviolet rays thereon, depending on the type of the polymer 22.

Subsequently, as shown in FIG. 4, the mold member 30 is separated from the polymer 22.

Afterwards, as shown in FIG. 5, a dual layer 24 is removed from the polymer 22 via O₂ plasma etching or the like, thereby forming a photonic crystal pattern 40 in the surface of the substrate 20.

However, the foregoing method of forming a photonic crystal pattern using nano-imprinting has a problem in that it is difficult to apply this method to a lens having a curved shape, since a planar mold member and a planar substrate must be used.

### DISCLOSURE

### Technical Problem

An object of the present invention is to provide a method for manufacturing a lens having a functional nanopattern, in which a nanopattern can be formed in the surface of a lens having a curved shape in order to increase light transmittance by minimizing reflections from the surface of the lens.

Another object of the present invention is to provide a method for manufacturing a lens having a functional nanopattern, which can increase productivity and reduce manufacturing costs.

### Technical Solution

The present invention pertains to a lens characterized by having a curved portion through which light passes, the curved portion having defined therein a photonic crystal pattern that can minimize reflections of light.

The photonic crystal pattern is characterized in that a polymer that forms the photonic crystal pattern in the surface is attached to the surface of the curved portion.

The present invention provides a method for manufacturing a lens having a functional nanopattern. The method includes a first step of forming a photonic crystal pattern on a stamper; and a second step of forming a photonic crystal pattern in the surface of a second polymer attached to the surface of a curved portion of a lens by pressing the stamper against the curved portion of the lens.

In an embodiment of the invention, the first step includes a step of forming a photonic crystal pattern on a mold member; and a step of forming a photonic crystal pattern on a first polymer attached to the surface of a curved portion of a lens core by pressing the mold member against the lens core.

The stamper is the lens core to which the first polymer, with the photonic crystal pattern formed therein, is attached.

In another embodiment of the invention, the stamper is a mold member, which is made of a material that stays deformable after being cured from a liquid to a solid.

In a further embodiment of the invention, the first step includes a step of applying a pattern-forming material on a curved portion of the lens core; a step of applying an optical polymer on the surface of the pattern-forming material; forming a pattern hole in the optical polymer, the pattern hole conforming to the photonic crystal pattern; forming the photonic crystal pattern in the pattern-forming material by etching; and removing the optical polymer. The stamper is a lens core to which the pattern-forming material, with the photonic crystal pattern formed therein, is attached.

### Advantageous Effects

As described above, the present invention has an effect such that reflection loss can be minimized by attaching a polymer having a photonic crystal pattern to the surface of a curved portion of a lens, thereby increasing light transmittance.

### DESCRIPTION OF DRAWINGS

FIG. 1 is a view showing transmission and reflection of light when the light travels from a medium having a refractive index greater than 1 into the air, which has a refractive index of 1;

FIGS. 2 to 5 are views showing the sequence of a process of forming a photonic crystal pattern in the surface of a medium using nano-imprinting technology of the related art;

FIGS. 6 to 13 are views showing the sequence of a process of forming a photonic crystal pattern in the surface of a lens according to an exemplary embodiment of the invention;

FIGS. 14 to 16 are views showing the sequence of a process of forming a photonic crystal pattern in the surface of a lens according to a second exemplary embodiment of the invention; and

FIGS. 17 to 22 are views showing the sequence of a process of forming a photonic crystal pattern in the surface of a lens according to a third exemplary embodiment of the invention.

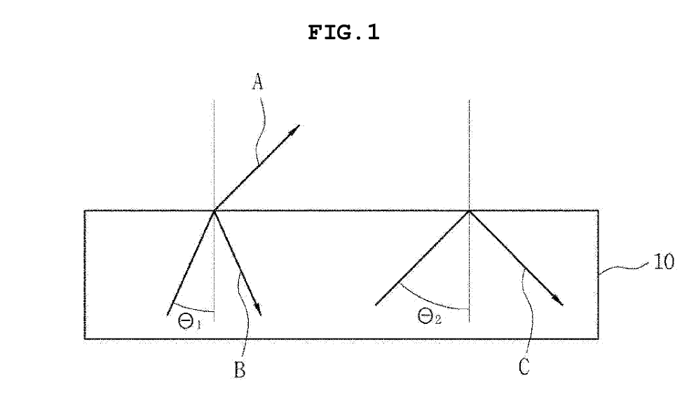

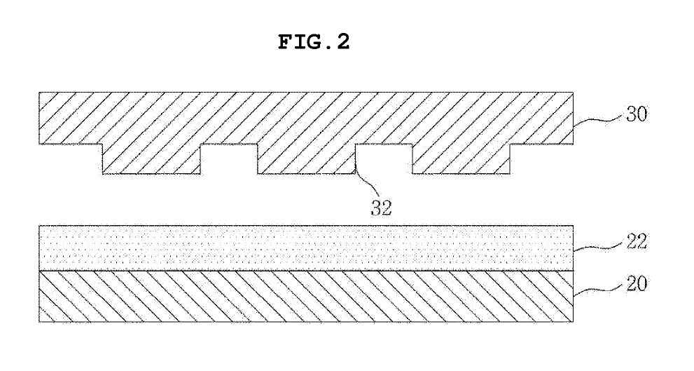

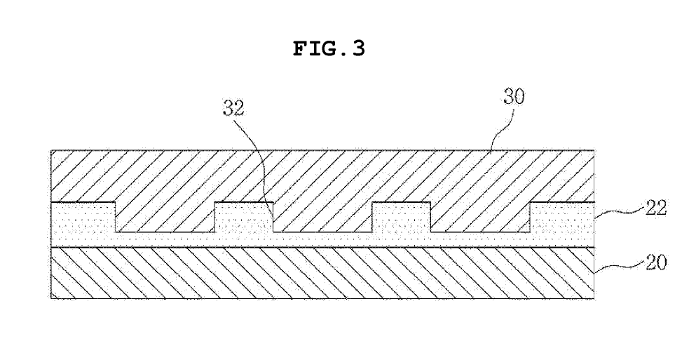

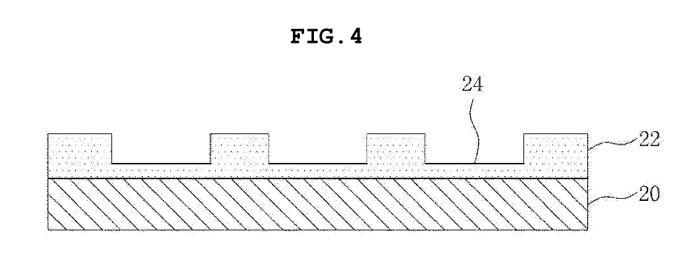

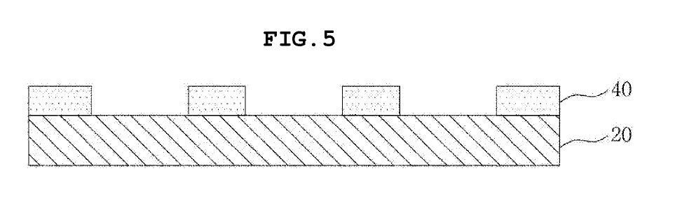

### BEST MODE

The present invention will, now be described, more fully hereinafter with reference to the accompanying drawings, in which exemplary embodiments thereof are shown.

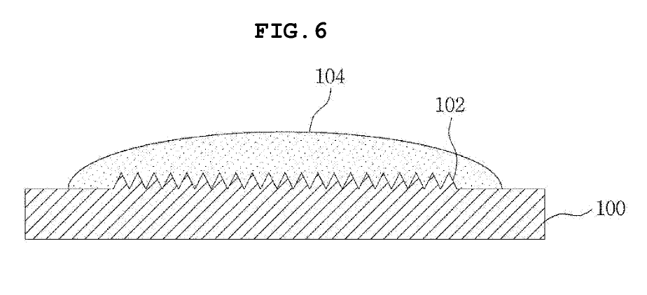

FIGS. 6 to 13 are views showing the sequence of a process of forming a photonic crystal pattern in the surface of a lens according to an exemplary embodiment of the invention.

Referring to FIGS. 6 to 13, a description will be made of the process of forming a photonic crystal pattern in the surface of a lens according to an exemplary embodiment of the invention.

First, as shown in FIG. 6, a photonic crystal pattern 102 is formed in the surface of a base substrate 100. Here, it is preferred that the base substrate 100 be planar, and that it be implemented with a silicon wafer or a quartz wafer. In addition, the photonic crystal pattern 102 is suitably configured such that it can greatly reduce Fresnel reflection and total reflection.

In addition, a liquid mold member 104 is applied to a predetermined thickness on the surface of the base substrate 100 on which the photonic crystal pattern 102 is formed. Here, it is preferred that the mold member 104 be made of a material, such as Polydimethylsiloxane (PDMS), that can stay flexible even after being cured from a liquid to a solid.

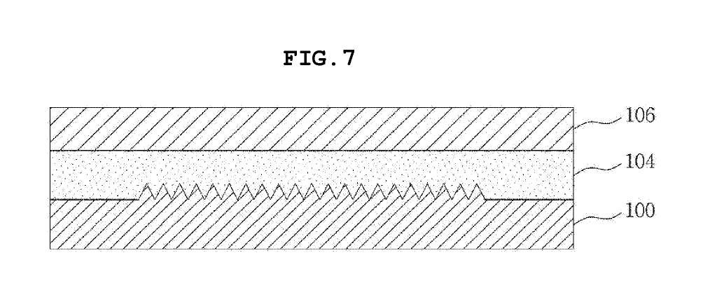

Afterwards, as shown in FIG. 7, the surface of the liquid mold member 104 is flattened by covering and pressing it with a support plate 106, and heat or infrared radiation is applied on the resultant structure. Consequently, the liquid mold member 104 is cured from a liquid to a solid.

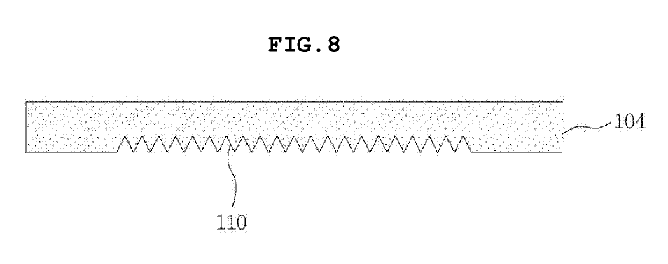

Afterwards, as shown in FIG. 8, the support plate 106 and the base substrate 100 are removed from the mold member 104. As a result, a photonic crystal pattern 110 the same as the photonic pattern 102 on the base substrate 100 is formed in the surface of the mold member 104. Here, the photonic crystal pattern 110 formed on the mold member 104 has a pillar pattern shape, which is inverse to the hole pattern shape of the photonic pattern 102 formed on the base substrate 100.

The mold member 104 retains a deformable flexible property due to its characteristics, even after being cured into a solid.

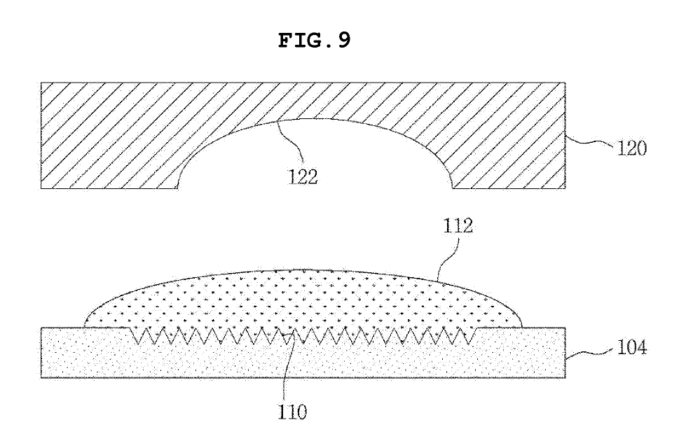

Afterwards, as shown in FIG. 9, a first polymer 112 is applied on the surface of the mold member 104, and a lens core 120 having a curved portion 122 is disposed above the first polymer 112, the shape of the curved portion being the same as that of the curved portion of a lens.

Here, it is preferred that the first polymer 112 be implemented as a photocurable polymer that cures when light is radiated thereon. A material that has excellent bonding strength to the plate 120 and is easily detachable from the mold member 104 can be selected. In addition, it is preferred that the inner surface of the curved portion 122 of the plate 120 be pretreated in order to increase the bonding strength to the first polymer 112.

In addition to the photocurable polymer, a thermal polymer that cures when heat is applied can be used as the first polymer 112. That is, the first polymer 112 can be implemented as a polymer that is curable in response to heat or light.

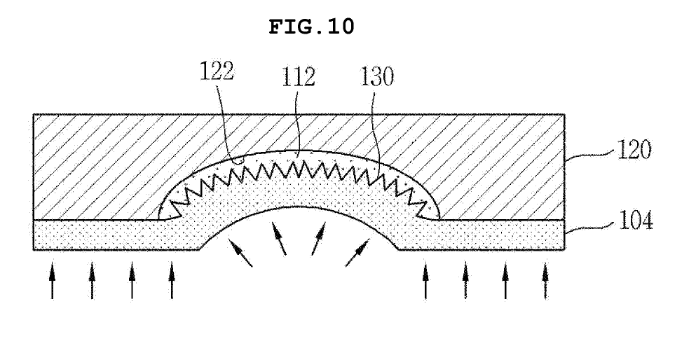

In addition, as shown in FIG. 10, pressure is applied on the underside of the mold member 104. Then, the mold member 104 is deformed and imparted with the same shape as that of the curved portion 122 formed on the lens core 120. Consequently, the upper surface of the first polymer 112 is attached to the inner surface of the curved portion 122 such that it has the same shape as the curved portion 122, and a photonic crystal pattern 130 having the same shape as that of the photonic crystal pattern 110 formed on the mold member 104 is transferred to the underside of the first polymer 112. Here, it is preferred that the pressure applied on the mold member 104 be hydrostatic pressure so that uniform pressure can be applied on the underside of the mold member 104.

Afterwards, the first polymer 112 is cured by radiating ultraviolet rays on the first polymer 112 if it is a photocurable polymer or applying heat on the first polymer 112 if it is a thermal polymer, and the mold member 104 is removed from the first polymer 112. Consequently, the first polymer 112, having the same curved shape as that of the curved portion of the lens, is attached to the curved portion 122 of the lens core 120, and the photonic crystal pattern 130 is formed in the surface of the first polymer 112.

Here, the photonic crystal pattern 130 is formed as a hole pattern that is inverse to the pillar pattern of the photonic crystal pattern 110 formed on the mold member 104.

The following steps are performed using the lens core, to which the first polymer having the photonic crystal pattern is attached, as a stamper.

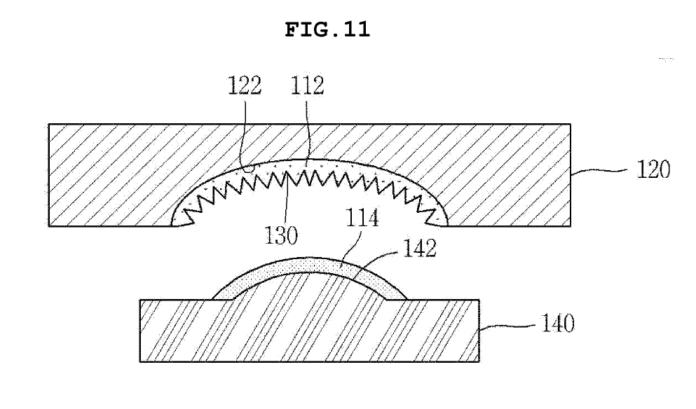

Afterwards, as shown in FIG. 11, a lens 140 having a curved portion 142 is positioned below the lens core 120 to which the first polymer 112 is attached, and a second polymer 114 is applied on the curved portion 142 of the lens 140. Here, it is preferred that the second polymer 114 be implemented as a material that has excellent bonding strength to the surface of the lens 140 and is easily detachable from the first polymer 112.

Although the curved portion of the lens has been described as being convex in this embodiment, this is not intended to be limiting. Rather, various shapes, such as a concave shape, a spherical shape, or an aspherical shape, can be applied.

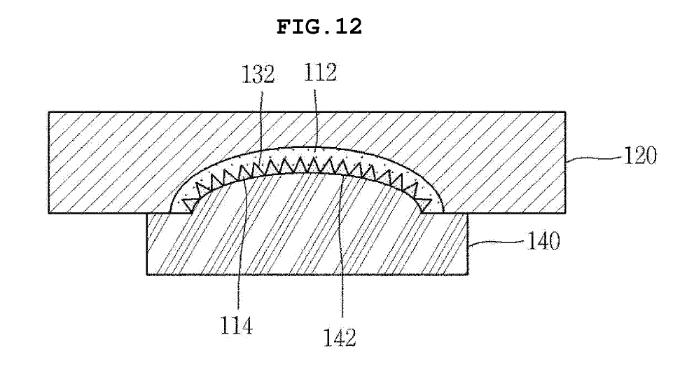

Afterwards, as shown in FIG. 12, the curved portion 142 of the lens 140 is inserted into the curved portion 122 of the lens core 120, and then predetermined pressure is applied thereon. Consequently, a photonic crystal pattern 132 the same as the photonic crystal pattern 130 formed on the first polymer 112 is formed in the surface of the second polymer 114, which is bonded to the curved portion 142 of the lens 140. Here, the photonic crystal pattern 132 formed on the second polymer 114 has a pillar pattern, since it is replicated from the photonic crystal pattern 130 having the hole pattern. Afterwards, the second polymer 114 is cured by radiating ultraviolet rays or heat thereon.

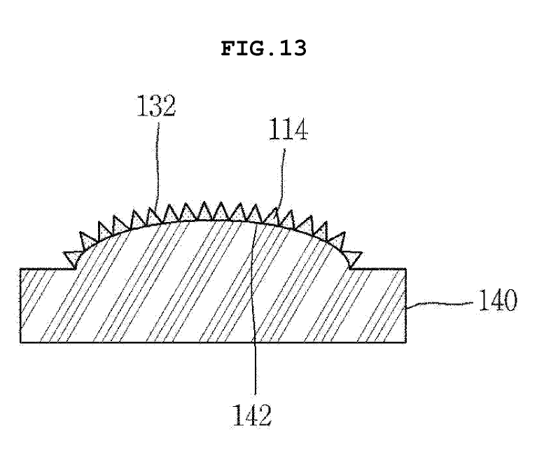

Afterwards, as shown in FIG. 13, the lens 140 is removed from the lens core 120. Consequently, the first polymer 112 and the second polymer 114 are detached from each other, with the second polymer 114, having the photonic crystal pattern 132, being attached to the surface of the curved portion 142 of the lens.

Since the photonic crystal pattern 132 can be formed in the surface of the curved portion 142 of the lens 140 through the foregoing process, it is possible to minimize reflection loss and increase light transmittance.

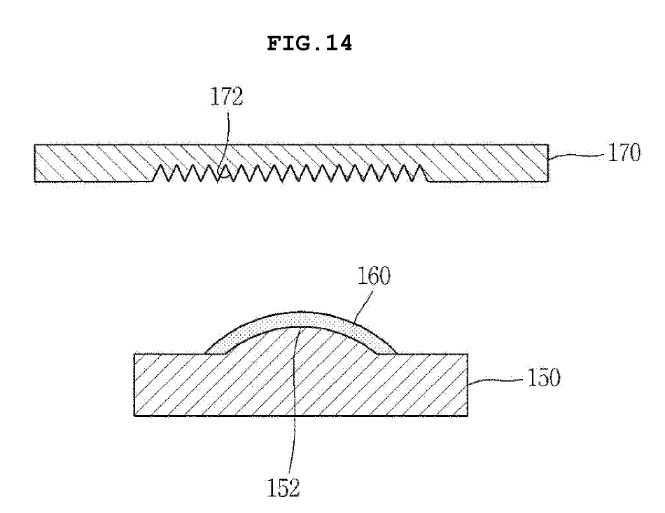

FIGS. 14 to 16 are views showing the sequence of a process of forming a photonic crystal pattern in the surface of a lens according to a second exemplary embodiment of the invention.

Referring to FIGS. 14 to 16, the process of forming a photonic crystal pattern in the surface of a lens according to the second exemplary embodiment is described.

First, as shown in FIG. 14, a polymer 160 is applied on the surface of a curved portion 152 of a lens 150, and a mold member 170 is disposed above the lens 150, with a photonic crystal pattern 172 formed in the surface of the mold member 170.

The mold member 170 has the photonic crystal pattern 172, which is formed in the surface thereof through the same process as the process that is used to form the photonic crystal pattern 110 in the surface of the mold member 104, which was described in the foregoing embodiment. Here, it is preferred that the photonic crystal pattern 172 have the form of a hole pattern.

The polymer 160 is implemented with a material that has excellent bonding strength to the surface of the lens 150 and is easily detachable from the mold member 104.

In this embodiment, the mold member is itself used as a stamper.

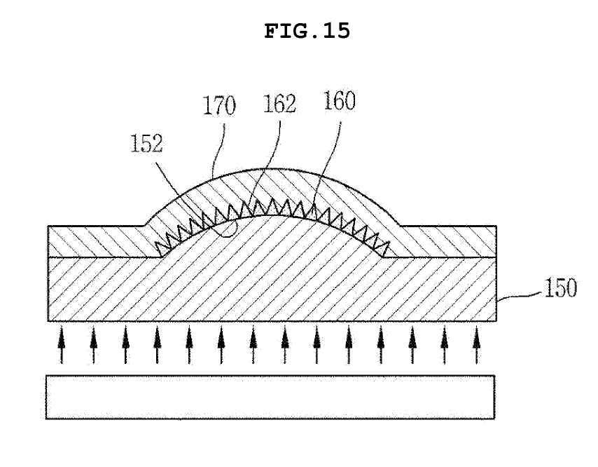

Afterwards, as shown in FIG. 15, the mold member 170 is brought into close contact with the surface of the curved portion 152 of the lens 150 by applying pressure against the rear surface of the mold member 170. Here, since the mold member 170 is made of a deformable material, it is deformed into a shape that is the same as that of the curved portion 152 of the lens 150.

Consequently, a photonic crystal pattern 162 the same as the photonic crystal pattern 172 in the mold member 170 is transferred to the surface of the polymer 160. Here, the photonic crystal pattern 162 has a pillar pattern shape, since it is replicated from the photonic crystal pattern 172, which has a hole pattern shape.

Afterwards, the first polymer 160 is cured by radiating ultraviolet rays thereon if a photocurable polymer is used, or by applying heat thereon if a thermal polymer is used.

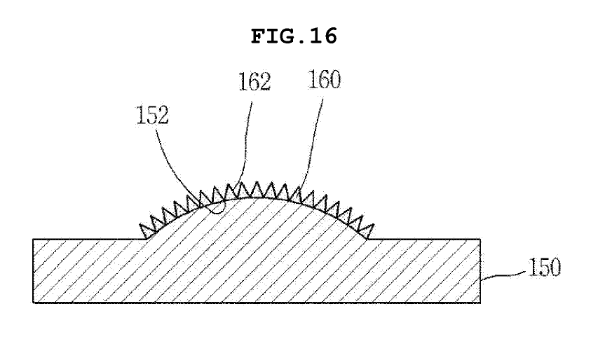

Afterwards, as shown in FIG. 16, the lens 150 is removed from the mold member 170, with the polymer 160, having the photonic crystal pattern 162, attached to the surface of the curved portion 152 of the lens 150.

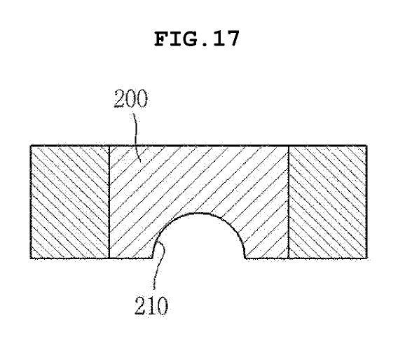

FIGS. 17 to 22 are views showing the sequence of a process of forming a photonic crystal pattern in the surface of a lens according to a third exemplary embodiment of the invention.

First, as shown in FIG. 17, a lens core 200 having a concave cavity 210 in the form of a lens is prepared. Here, it is preferred that the cavity 210 be a curved surface having a spherical or aspherical shape.

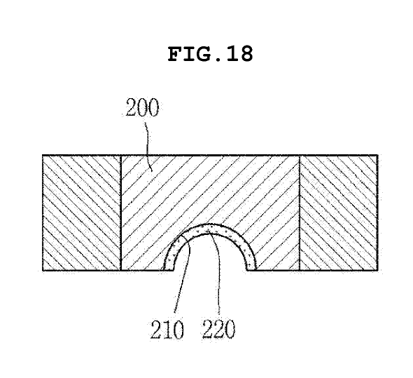

Afterwards, as shown in FIG. 18, a pattern-forming material 220 is applied to a predetermined thickness on the inner surface of the cavity 210. Here, it is preferred that the pattern-forming material 220 be made of a ceramic material, such as SiO₂, which has a predetermined strength and is intended to form a photonic crystal pattern in the subsequent process.

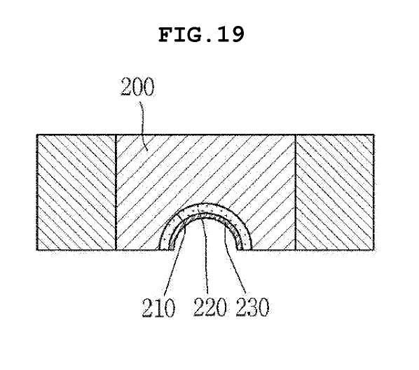

Subsequently, as shown in FIG. 19, an optical polymer 230 is applied on the surface of the pattern-forming material 220. Here, it is preferred that the optical polymer 230 be implemented as a photocurable polymer that cures when light is radiated thereon or a thermal polymer that cures when heat is applied thereto. In addition, the optical polymer 230 can be a material that is easily separated from the pattern-forming material 220.

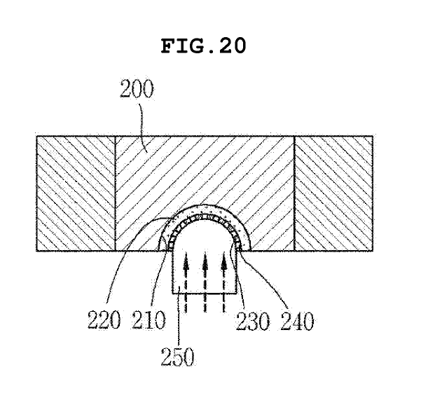

Afterwards, as shown in FIG. 20, a glass mold member 250 is pressed inwards against the surface of the optical polymer 230, with a photonic crystal pattern formed in the surface of the mold member 250. A variety of mold members, such as the foregoing mold member 104, can be used in place of the glass mold member 250.

Consequently, a pattern hole 240 that conforms to the photonic crystal pattern formed in the glass mold member 250 is formed in the optical polymer 230. The pattern hole 240 has a hole pattern shape, since it is replicated from the photonic crystal pattern, which has a pillar pattern shape.

Afterwards, when heat is applied or ultraviolet rays are radiated through the glass mold member 250, the optical polymer 230 cures, and the pattern hole 240 is formed in the optical polymer 230 such that it penetrates the optical polymer 230.

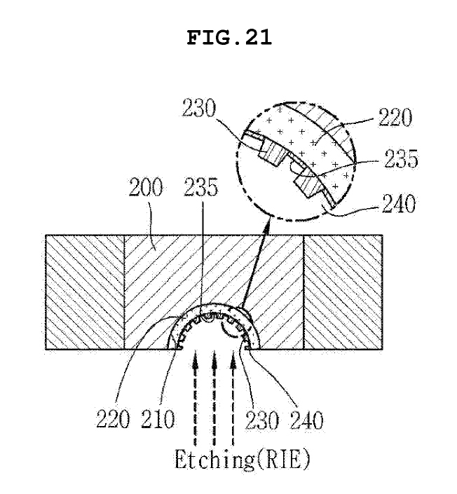

In this state, as shown in FIG. 21, after the glass mold member 250 is removed from the optical polymer 230, a process of removing a residual layer 235 from the pattern hole 240 is performed. Specifically, when the glass mold member 250 is removed after the pattern 240 is formed in the optical polymer 230 using the glass mold member 250, the residual layer 235 is formed on the pattern hole 240, and the process of removing the residual layer 235 is performed.

When the residual layer 235 is removed as described above, an etching process is performed.

The optical polymer 230 acts as a mask, and a photonic crystal pattern 260 is formed in the pattern-forming material 220 through the pattern hole 240 that is formed in the optical polymer 230.

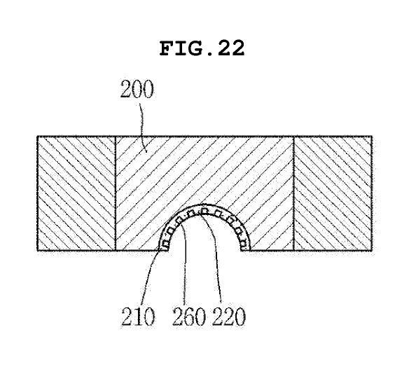

Afterwards, as shown in FIG. 22, the optical polymer 230 is removed, thereby finally forming a lens core 200 having the photonic crystal pattern 260 formed in the pattern-forming material 220. Here, the process of removing the optical polymer 230 can be implemented by etching, and any process with which the optical polymer 230 can be removed from the pattern-forming material 220 can be applied. The subsequent process of forming a photonic crystal pattern in the surface of the lens using a lens core having a photonic crystal pattern formed thereon is substantially the same as the process described in the foregoing embodiment.

While the present invention has been shown and described with reference to certain exemplary embodiments thereof, it will be understood by those skilled in the art that various changes in forms and details may be made therein without departing from the spirit and scope of the present invention as defined by the appended claims and their equivalents.

1. A method for manufacturing a lens having a functional nanopattern, comprising:
a first step of forming a photonic crystal pattern on a stamper; and
a second step of forming a photonic crystal pattern in a surface of a second polymer attached to a surface of a curved portion of a lens by pressing the stamper against the curved portion of the lens.

2. The method of claim 1, wherein the first step comprises:
a step of forming the photonic crystal pattern on a mold member; and
a step of forming the photonic crystal pattern on a first polymer attached to a surface of a curved portion of a lens core by pressing the mold member against the lens core,
wherein the stamper is the lens core to which the first polymer, with the photonic crystal pattern formed therein, is attached.

3. The method of claim 2, wherein the step of forming the photonic crystal pattern on the mold member comprises:
a step of applying a liquid mold member on a surface of a base substrate having a photonic crystal pattern thereon; and
a step of covering the surface of the liquid mold member with a support plate and curing the liquid mold member by radiating heat or ultraviolet rays thereon.

4. The method of claim 3, wherein the base substrate is a silicon wafer or a quartz wafer.

5. The method of claim 2, wherein the mold member is made of a flexible material such that the mold member comes in close contact with the curved portion of the lens core.

6. The method of claim 2, wherein the mold member is made of Polydimethylsiloxane (PDMS).

7. The method of claim 2, wherein the step of forming a photonic crystal pattern on a first polymer comprises:
a step of applying the first polymer on a surface of the mold member;
a step of transferring the photonic crystal pattern formed on the mold member to a surface of the first polymer by placing the lens core having a curved portion over the mold member and applying pressure on the mold member; and
a step of curing the first polymer and removing the mold member from the first polymer.

8. The method of claim 7, wherein the first polymer is a photocurable polymer or a thermosetting polymer.

9. The method of claim 7, wherein an inner surface of the curved portion of the lens core is pretreated in order to increase bonding strength with the first polymer.

10. The method of claim 7, wherein the pressure applied on the mold member is hydrostatic pressure such that the pressure is uniformly applied on an entire area of an underside of the mold member.

11. The method of claim 2, wherein the second step comprises:
a step of applying the second polymer on the curved portion of the lens;
a step of forming a photonic crystal pattern in the surface of the second polymer, the photonic crystal pattern in the surface of the second polymer conforming to the photonic pattern formed on the first polymer, by inserting the curved portion of the lens into the curved portion of the lens core and applying pressure on the lens; and
curing the second polymer by radiating ultraviolet rays or heat thereon, and removing the lens from the lens core.

12. The method of claim 1, wherein the stamper is a mold member, wherein the mold member is made of a material that stays deformable after being cured from a liquid to a solid.

13. The method of claim 12, wherein the mold member is made of Polydimethylsiloxane (PDMS).

14. The method of claim 12, wherein the first step comprises:
a step of applying a liquid mold member on a surface of a base substrate having a photonic crystal pattern thereon; and
a step of covering the surface of the liquid mold member placing with a support plate and curing the liquid mold member by applying heat or ultraviolet rays thereon.

15. The method of claim 14, wherein the base substrate is a silicon wafer or a quartz wafer.

16. The method of claim 12, wherein the second step comprises:
a step of applying the second polymer on the curved portion of the lens;
a step of transferring the photonic crystal pattern formed on the mold member to the second polymer by pressing the mold member so that the mold member comes into close contact with the surface of the curved portion; and
curing the second polymer by radiating ultraviolet rays or heat thereon, and separating the lens and the mold member from each other.

17. The method of claim 1, wherein the first step comprises:
a step of applying a pattern-forming material on a curved portion of the lens core;
a step of applying an optical polymer on a surface of the pattern-forming material;
forming a pattern hole in the optical polymer, the pattern hole conforming to the photonic crystal pattern;
forming the photonic crystal pattern in the pattern-forming material by etching; and
removing the optical polymer,
wherein the stamper is a lens core to which the pattern-forming material, with the photonic crystal pattern formed therein, is attached.

18. The method of claim 17, wherein the pattern forming material is made of SiO₂.

19. The method of claim 17, wherein the step of forming a pattern hole in the optical polymer comprises:
pressing a mold member, with a photonic crystal pattern formed therein, inwards against the optical polymer; and
curing the optical polymer by radiating heat or ultraviolet rays thereon.
